(19) United States
(12) Patent Application Publication
(10) Pub. No.: US 2007/0099460 A1
(43) Pub. Date: May 3, 2007

(54) Tool for closing and separating pluggable quick acting closure couplings

(76) Inventor: Guenter Holp, Murrhardt (DE)

Correspondence Address: FLYNN THIEL BOUTELL & TANIS, P.C., 2026 RAMBLING ROAD, KALAMAZOO, MI, 49008-1631, US

(21) Appl. No.: 10/593,218

(22) PCT Filed: Mar. 17, 2005
(86) PCT No.: PCT/DE05/00507

§ 371 Date: Sep. 15, 2006

(30) Foreign Application Priority Data
Mar. 17, 2004 (DE) 10 2004 013 400.6

(51) Int. Cl. H01R 13/62

(52) U.S. Cl. 439/157

(57) ABSTRACT

The invention relates to a tool for closing and separating pluggable quick acting closure couplings for hydraulic lines (12), comprising two engaging elements (18), each of which can be engaged with a coupling half (14, 16) of the quick acting closure coupling (10) and an actuation mechanism (20) enabling the plug-in movement of the coupling halves (14, 16) by performing a reciprocal relative movement of the engaging elements (18). In order to ensure reliable and simple operation, the actuation mechanism (20) has a linear guide (28) consisting of two guide parts (32, 34) that can be moved linearly one towards the other. The engaging elements (18) protrude crosswise with respect to the guide track (30) in each of the guide parts as projections.

The invention relates to a tool for closing and separating pluggable quick acting closure couplings for hydraulic lines, in particular of construction machines, with two engagement elements which can be brought into engagement with in each case one coupling half of the quick acting closure coupling, and with an actuating mechanism, which can preferably be handled manually, for the plugging-in movement of the coupling halves via a mutual relative movement of the engagement elements.

Known tools of this type are designed as devices in the manner of pliers in order, by the compression of the handle ends, to bring about a mutually pivoting movement of two ends of the pliers which receive the coupling halves. However, it is disadvantageous here that the coupling parts tilt easily and the mutual friction is too high. Especially under oil pressure in the ends of the lines, it is also scarcely possible with auxiliary devices of this type to actuate the quick acting closure couplings in the desired manner without excessive manual use of force.

Starting from this, the invention is based on the object of avoiding the disadvantages which have occurred in the prior art and of improving a tool of the type specified at the beginning to the effect that, even in rough working use, simple and reliable actuation of the coupling is possible.

To achieve this object, the combination of features specified in the independent patent claims is proposed.

Advantageous refinements and developments of the invention emerge from the dependent claims.

The invention is based on the concept of moving the coupling halves in alignment with each other linearly. Accordingly, it is provided that the actuating mechanism has a linear guide which comprises two guide parts which are displaceable linearly in relation to each other, and in that the engagement elements protrude transversely to the guide track on one guide part in each case to form extension arms. As a result, it is possible to bring about the plugging-in movement reliably without tilting, with force being introduced into the guide parts in a low-wearing manner and sufficient clearance being provided via the extension arms.

The coupling halves are advantageously movable linearly along a plug-in axis running parallel to the guide track at a lateral distance between the engagement elements, so that the applied forces are optimally used.

In an embodiment which is particularly simple structurally and at the same time is unaffected by loading, the linear guide has a tube and a rod, which is longitudinally displaceable therein, as guide parts.

A further important aspect of the invention is that the actuating mechanism has a handle tube and a rod, which is displaceable longitudinally therein, as a linear guide for the engagement elements, and that the handle tube at the same time forms a hand lever for the manual actuation. It is thereby possible to carry out the plugging-in movement in a metered manner, with simple handling being possible. A further improvement is obtained in that the handle tube runs parallel to a plug-in axis and has a handle piece on a free end section.

It is also advantageous if the linear guide is secured against rotation by a sliding block guided in a groove or by a polygonal cross section.

For variable use, it is advantageous if the engagement elements can be fixed on the guide parts via releasable connecting means. A further improvement provides that the connecting means have an adjustment region running in the direction of the guide track, in particular a screw thread for setting the position of the engagement elements.

In order to ensure simple handling and reliable transmission of force, it is advantageous if the engagement elements can be brought into form-fitting connection with the coupling halves. It is advantageous here if the engagement elements each have a fork-shaped piece for engaging laterally around a coupling half. In this case, it is also conceivable for the engagement elements to be able to be closed in the manner of pliers for adaptation to different diameters of the coupling halves.

A further advantageous variant provides that the engagement elements can be coupled to adaptor pieces, in particular adaptor disks, for adaptation to different diameters of the coupling halves. This can take place in that the adaptor pieces can be inserted into a receptacle of the engagement elements or can be fitted on the coupling halves.

A structurally advantageous adaptation provides that the fork-shaped pieces are formed by ring segment bodies which can be placed onto the coupling halves via an edge aperture and are connected to the guide parts at a ring portion lying opposite the edge aperture. In order to increase the loading strength, the central opening of the ring segment bodies is to be displaced eccentrically with respect to the ring body axis toward the edge aperture.

In order to permit simple adaptation to different couplings, it is advantageous if the engagement elements each have a conically widening opening in the plugging-in direction for receiving a coupling half, the central axes of the openings being aligned with each other. This also achieves reliable centering for plugging together in a tilt-free manner.

A further variant provides that at least one engagement element is designed as a hook and can be fitted on a coupling half or on a mount supporting the coupling halves.

A particular concept of the invention consists in the actuating mechanism having a handle tube and a rod, which can be displaced longitudinally therein, as a linear guide for the engagement elements, and a manually actuated pivot lever, which is connected to the handle tube in an articulated manner via a deflecting mechanism, for transferring the movement of the pivot lever into a linear movement in a manner free from jamming. The double lever permits a scissors-type actuation while the deflecting mechanism converts the pivoting movement via articulated elements into a linear movement on the handle tube without the guide being able to become jammed in the process.

In order to further facilitate the handling, it is favorable if the actuating mechanism has at least one pivot lever and a deflecting mechanism for transferring the movement of the pivot lever into the linear movement of the guide parts.

In particular for single-handed actuation when releasing the coupling, it is advantageous if the pivot lever is bent at its end coupled to the linear guide, so that, during a pivoting actuation, the free lever end of the pivot lever comes into a small angular position with a guide part which can be handled as the counter lever.

A further preferred embodiment provides that the pivot lever is supported pivotably on a guide part via a coupling element, and in that the coupling element can be adjusted longitudinally on the guide part in the guide direction and can be fixed in a desired adjustment position, preferably in a self-holding manner. This results in a large adjustment distance for adaptation independent of the manufacturer to different couplings while, in the adjustment position, a large force can be applied with a small pivoting movement of the pivot lever.

The deflecting mechanism advantageously has a double-jointed tension lever coupled to the pivot lever and to a guide part. For converting the movement, it is furthermore advantageous if the deflecting mechanism comprises, as the coupling element, a drag lever which is coupled to the pivot lever at a distance from the tension lever, the drag lever being mounted with play on the guide part, which is free from the tension lever, via a clamping aperture, so that, if the drag lever tilts, the guide part comes into clamping connection in a self-holding manner in the clamping aperture. In order to facilitate a pre-adjustment, it is advantageous if the drag lever is held via a supporting spring at a distance from the guide part to be drawn up. Alternatively to the drag lever, it is also possible that the deflecting mechanism has a rack, which is connected fixedly to one of the guide parts, for fitting a fulcrum pin of the pivot lever into.

The invention is explained in more detail below with reference to the exemplary embodiments illustrated in the drawing, in which:

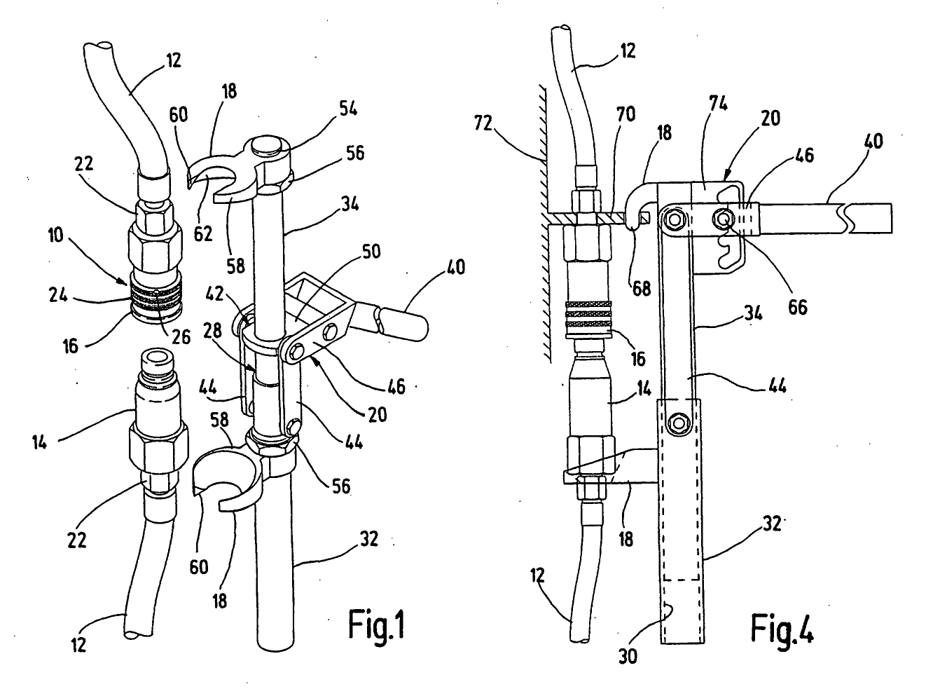

FIG. 1 shows an auxiliary tool for quick acting closure couplings of hydraulic lines in a perspective illustration;

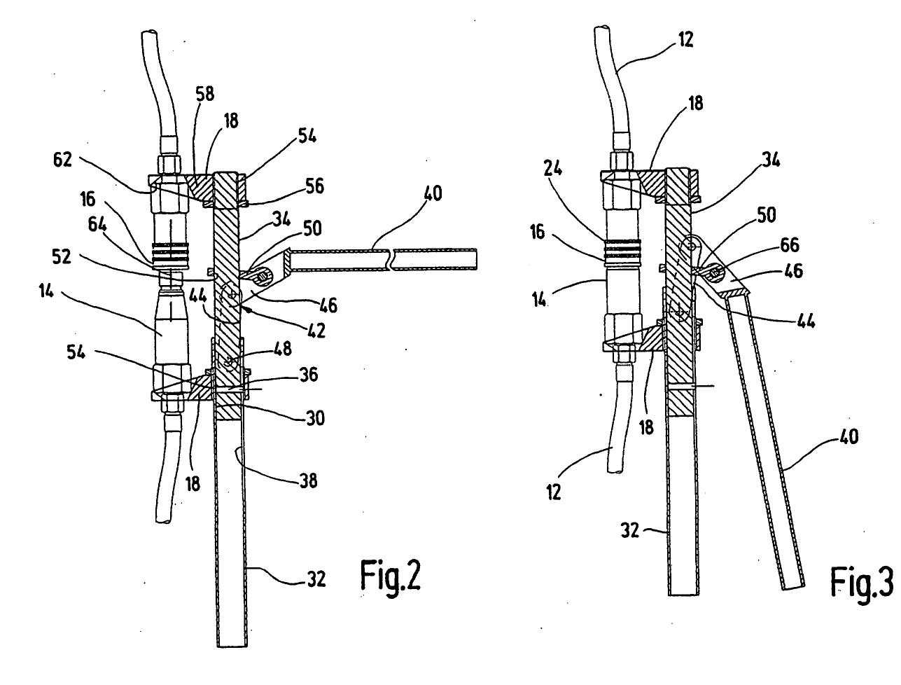

FIG. 2 shows the tool in conjunction with the quick acting closure coupling in the starting position, in a longitudinal section;

FIG. 3 shows the closed position of the tool in an illustration corresponding to FIG. 2; and

FIG. 4 shows a further embodiment in a side view.

The tool illustrated in the drawing serves for the closing and separating of pluggable quick acting closure couplings 10 of hydraulic lines 12, as are provided, in particular on construction machines, for actuating working implements. The tool essentially comprises two engagement elements 18 which can be brought into engagement with in each case one coupling half 14, 16 of the quick acting closure coupling 10, and an actuating mechanism 20, which can be handled manually, for the coaxial plugging-in movement of the coupling halves 14, 16 via a mutual linear displacement of the engagement elements 18.

The coupling halves 14, 16 are connected to the ends of the hydraulic line 12 via a screw connection 22 and make it possible for them to be shut off in the separated state, which is shown in FIG. 1, via a respective integrated valve (not shown). To produce a hydraulic connection with automatic opening of the valves, the coupling halves in the form of a connector 14 and a socket 16 can be plugged together and can be locked in the connecting position by an axially displaceable sliding sleeve 24. The separation of the coupling 10 can be brought about by the sliding sleeve 24 being pushed back counter to a restoring spring, with it being possible for the release of the locking ball lock 26 to be facilitated by pressing the coupling halves 14, 16 together in the closing direction. However, particularly under oil pressure, the actuation of the coupling requires a high amount of effort, which can be considerably simplified by the use of the auxiliary tool.

For this purpose, the actuating mechanism 20 has a linear guide 28 which comprises two guide parts 32, 34 which can be displaced linearly in relation to each other along a guide track 30. The engagement elements 18 protrude transversely to the guide track 30 on a respectively assigned guide part 32, 34 to form extension arms.

As can best be seen in FIGS. 2 and 3, the one guide part 32 is designed as a round tube while the other guide part 34, as a round bar or rod, can be displaced telescopically therein. With a mutual securing against rotation, the rod 34 is guided via a radially protruding securing pin 36 in a longitudinal groove 38 of the tube 32.

For the manual drive of the guide halves 32, 34, the actuating mechanism 20 has a pivot lever 40 and a deflecting mechanism 42. The deflecting mechanism 42 comprises a pair of double-jointed tension levers 44 which are coupled to a bent fork end 46 of the actuating lever 40 and to articulated points 48 of the guide tube 32 lying diametrically opposite each other. For support on the rod 34, the deflecting mechanism 42 has a drag lever 50 which is coupled to the fork end 46 at a distance from the tension lever 44 and is mounted with play on the rod 34 via a transverse hole 52.

The extension arms 18 can be screwed onto the end side of the guide tube 32 or the guide bar 34 via a respective screw connection 54. By interchanging the extension arms 18, a simple adaptation to different couplings 10 can be achieved, with the desired screw-in position being secured by a locknut 56.

For a form-fitting connection to the coupling halves 14, 16, the extension arms 18 each have a fork-shaped piece 58 designed as ring segment bodies (cf. FIG. 1). The ring segment bodies 58 can be placed laterally onto the hydraulic line 12 in the region of the connecting ends 22 via an edge aperture 60, with the conical opening 62 of the ring segment bodies 58 supporting the coupling halves 14, 16 on the rear side. The axis of the opening 62 is displaced eccentrically in relation to the ring axis of the ring segment body 58 toward the edge aperture 60, so that greater loading strength for the rigid connecting portion of the ring segment bodies 58 with the guide parts 32, 34 is produced.

The central axes of the receiving openings 62 are aligned in a plug-in axis 64 of the coupling 10. The plug-in axis 64 is arranged at a lateral distance parallel to the guide track 30 of the linear guide 28 via the extension arms 18.

The actuation of the tool is explained in more detail below. First of all, the ends of the hydraulic line 12 are brought into engagement with the extension arms 18 in the position shown in FIG. 1. The guide parts 32, 34 can be pushed together here without particular effort until the starting position shown in FIG. 2 is reached, in which the coupling halves 14, 16 bear against each other by their flat end sides (“flat-face coupling”). In order not to obstruct the adjustment movement of the guide halves 32, 34, the drag lever 50 is held via a spring (not shown) at a distance from the end side of the end of the guide tube, so that it initially does not jam.

Subsequently, according to FIG. 3, the pivot lever 40 is pivoted against the guide tube 32. In the initial phase of the pivoting movement, the drag lever 50 tilts and, as a result, reaches a clamping position on the rod 34 in which it is fixed against displacement. The pivot pin is therefore situated in the drag lever joint 66, with the pivoting movement being converted via the tension lever 44 into an upward movement of the guide tube 32 on the rod 34. The coupling halves 14, 16 are therefore also moved in the plug-in axis 64 until the closed position is reached.

The tool also facilitates the separating of the coupling 10. In this case, an additional closing force can be applied in the position shown in FIG. 3 in order to be able more easily to unlock the locking ball lock 26 and to push the sliding sleeve 24 upward. For simplified handling, the pivot lever 40 is bent at its fork end 46, so that the free lever end can be operated single-handedly in a small angular position with the guide tube 32, which can be handled as the counter lever, and the other hand remains free for unlocking the coupling.

In the case of the exemplary embodiment shown in FIG. 4, parts which are identical to the ones described above are provided with the same reference numbers. A particular difference is that the rod-side engagement element 18 has a hook 68 which can be fitted in a mount 70 supporting the upper coupling half 16. Said mount is arranged in a rigid connection on a wall 72 of the construction machine. The mount 70 forms part of an extension arm of the rod 34 in order to hold the coupling half 16 coaxially to the coupling half 14 in the tube-side extension arm 18.

A further difference of this embodiment is that the deflecting mechanism 20 has a rack 74 which is connected rigidly to the guide bar 34 and in which the pivot pin 66 of the pivot lever 40 can be fitted at various distances from the end of the rod. Also here, during a pivoting movement of the pivot lever 40 downward, the tension lever 44 brings about the deflection into a linear movement of the guide tube 32 and therefore a corresponding rectilinear plugging-in movement in the coupling halves 14, 16. It goes without saying that, instead of a pivot lever actuation, a spindle drive or other linear drives can also be provided to carry out the linear movement of the engagement elements. In principle, it is also possible, in the case of a stationary device, to use a hydraulic drive.

1. A tool for closing and separating pluggable quick acting closure couplings for hydraulic lines (12), in particular of construction machines, with two engagement elements (18) which can be brought into engagement with in each case one coupling half (14, 16) of the quick acting closure coupling (10), and with an actuating mechanism (20), which can be handled manually, for the plugging-in movement of the coupling halves (14, 16) via a mutual relative movement of the engagement elements (18), the actuating mechanism (20) having a linear guide (28) which comprises two guide parts (32, 34) which are displaceable linearly in relation to each other, and the engagement elements (18) protruding transversely to the guide track (30) on one guide part in each case to form extension arms, and the actuating mechanism (20) having a pivot lever (40) and a deflecting mechanism (20) for transferring the movement of the pivot lever into the linear movement of the guide parts (32, 34), characterized in that the deflecting mechanism (20) comprises a double-jointed tension lever (44) which is coupled to the pivot lever (40) and to a guide part (32) and a drag lever (50) coupled to the pivot lever (40) at a distance from the tension lever (44), and in that the drag lever (50) is held via a supporting spring at a distance from the guide part (32) to be drawn up.

2. The tool as claimed in claim 1, characterized in that the coupling halves (14, 16) are movable linearly along a plug-in axis (64) running parallel to the guide track (30) at a lateral distance between the engagement elements (18).

3. The tool as claimed in claim 1, characterized in that the linear guide (28) has a handle tube (32) and a rod (34), which is longitudinally displaceable therein, as guide parts (32, 34), and in that the handle tube (32) at the same time forms a hand lever for the manual actuation.

4. The tool as claimed in claim 3, characterized in that the handle tube (32) runs parallel to a plug-in axis and has a handle piece on a free end section.

5. The tool as claimed in claim 1, characterized in that the linear guide (28) is secured against rotation by a sliding block (36) guided in a groove (38) or by a polygonal cross section.

6. The tool as claimed in claim 1, characterized in that the engagement elements (18) can be fixed on the guide parts (32, 34) via releasable connecting means (54, 56).

7. The tool as claimed in claim 6, characterized in that the connecting means (54, 56) have an adjustment region running in the direction of the guide track (30), in particular a screw thread for setting the position of the engagement elements (18).

8. The tool as claimed in claim 1, characterized in that the engagement elements (18) can be brought into form-fitting connection with the coupling halves (14, 16).

9. The tool as claimed in claim 1, characterized in that the engagement elements (18) each have a fork-shaped piece (58) for engaging laterally around a coupling half (14, 16).

10. The tool as claimed in claim 1, characterized in that at least one engagement element is designed as a hook (68) and can be fitted on a coupling half (14, 16) or on a mount (70) supporting the coupling halves (14, 16).

11. The tool as claimed in claim 1, characterized in that the pivot lever (40) is bent at its end (46) coupled to the linear guide (28), so that, during a pivoting actuation, the free lever end of the pivot lever (40) comes into a small angular position with a guide part (32) which can be handled as the counter lever.

12. The tool as claimed in claim 1, characterized in that the pivot lever (40) is supported pivotably on a guide part (34) via a coupling element (50), and in that the coupling element (50) can be adjusted longitudinally on the guide part (34) in the guide direction and can be fixed in a desired adjustment position, preferably in a self-holding manner.

13. The tool as claimed in claim 1, characterized in that the drag lever (50) is mounted with play on the guide part (34), which is free from the tension lever (44), via a clamping aperture (52), so that, if the drag lever (50) tilts, the guide part (34) comes into clamping connection in the clamping aperture (52).

14. A tool for closing and separating pluggable quick acting closure couplings for hydraulic lines (12), in particular of construction machines, with two engagement elements (18) which can be brought into engagement with in each case one coupling half (14, 16) of the quick acting closure coupling (10), and with an actuating mechanism (20), which can preferably be handled manually, for the plugging-in movement of the coupling halves (14, 16) via a mutual relative movement of the engagement elements (18), the actuating mechanism (20) having a linear guide (28) which comprises two guide parts (32, 34) which are displaceable linearly in relation to each other, and the engagement elements (18) protruding transversely to the guide track (30) on one guide part in each case to form extension arms, and are formed by ring segment bodies (58) which can be placed onto the coupling halves (14, 16) via an edge aperture (60) and are connected to the guide parts (32, 34) at a ring portion lying opposite the edge aperture (60), characterized in that the engagement elements (18) each have a conically widening central opening (62) for receiving a coupling half (14, 16).

15. The tool as claimed in claim 14, characterized in that the central opening (62) of the ring segment bodies (58) is displaced eccentrically with respect to the ring axis toward the edge aperture (60).

16. The tool as claimed in claim 14, characterized in that the engagement elements (18) can be closed in each case in the manner of pliers for adaptation to different diameters of the coupling halves (14, 16).

17. The tool as claimed in claim 14, characterized in that the engagement elements (18) can be coupled to adaptor pieces, in particular adaptor disks, for adaptation to different diameters of the coupling halves (14, 16).

18. The tool as claimed in claim 17, characterized in that the adaptor pieces can be inserted into a receptacle of the engagement elements (18) or can be fitted on the coupling halves.

19. The tool as claimed in claim 14, characterized in that the central axes of the central openings (62) are aligned with one another.

20. The tool as claimed in claim 14, characterized in that the deflecting mechanism (20) has a rack (74), which is connected fixedly to one of the guide parts (32, 34), for fitting a fulcrum pin (66) of the pivot lever (40) into.

21-26. (canceled)
